(19) United States
(12) Patent Application Publication
(10) Pub. No.: US 2022/0057332 A1
(43) Pub. Date: Feb. 24, 2022

(54) RAMAN SCATTERING ENHANCING-SUBSTRATE AND METHOD OF MANUFACTURING THE SAME

(71) Applicant: THE UNIVERSITY OF TOKYO, Tokyo (JP)

(72) Inventors: Keisuke GODA, Tokyo (JP); Zhenzhou CHENG, Tokyo (JP); Ting-Hui XIAO, Tokyo (JP); Nan CHEN, Tokyo (JP)

(73) Assignee: THE UNIVERSITY OF TOKYO, Tokyo (JP)

(21) Appl. No.: 17/413,475

(22) PCT Filed: Dec. 4, 2019
(86) PCT No.: PCT/JP2019/047472

§ 371 Date: Nov. 2, 2021

(30) Foreign Application Priority Data
Dec. 12, 2018 (JP) 2018-232111

(51) Int. Cl. G01N 21/65; B82B 3/00; C01B 32/05

(52) U.S. Cl. CPC G01N 21/658; B82Y 35/00; C01B 32/05; B82B 3/0014

(57) ABSTRACT

A Raman scattering enhancing-substrate is provided by arraying a plurality of porous carbon elements in a columnar form or in a massive form made of a porous carbon material with holes of 10 to 50 nm in diameter, on a support base. This substrate is manufactured by, for example, filling a template that is made of anodic aluminum oxide to have an array of a plurality of holes in a columnar form or in a cube form, with pyrrole as a monomer and polymerizing the pyrrole-filling template to form a polypyrrole nanoarray; making the entire polypyrrole nanoarray porous to provide a porous polypyrrole nanoarray that is a porous body with pores of 10 to 50 nm in diameter; and carbonizing the porous polypyrrole nanoarray.

The present disclosure relates to a Raman scattering enhancing-substrate and a method of manufacturing the same. More specifically, the present disclosure relates to a Raman scattering enhancing-substrate having Raman scattering enhancing effects and a method of manufacturing such a substrate.

### BACKGROUND

A proposed configuration of a surface-enhancing Raman analysis substrate to enhance the optical response of a test substance includes a base material, a slab material located on the surface of the base material, and a metal material located at least on the slab material. The base material has a surface layer that comes into contact with at least the slab material. The slab material is made of a material having a higher refractive index than the refractive index of the surface layer and has a plurality of holes that are arranged periodically from the surface of the slab material to reach the surface layer of the base material. The metal material is located on the surface of the slab material and on the surface layer of the base material via the plurality of holes, has a complementary metal structure, and has multiple resonances determined by the diameter and the period of the plurality of holes (as described in, for example, Patent Literature 1). An Si substrate joined with an SiO₂ layer is used for the base material. The slab material is formed to have two or more refractive indexes and a thickness in a range of not less than 100 nm and not greater than 2 μm by using a material selected from the group consisting of Si, Ge, SiN, SiC, II-VI semiconductors III-V semiconductors and TiO₂. The metal material is formed to have a thickness of not less than 30 nm and not greater than 100 nm by using a material selected from the group consisting of Au, Pt, Ag, Cu, Pd, Co, Fe and alloys thereof. The plurality of holes arranged periodically from the surface of the slab material to reach the surface layer of the base material are formed to have diameters in a range of not less than 100 nm and not greater than 500 nm and to have periods in a range of not less than 300 nm and not greater than 1000 nm. This substrate is expected to increase the intensity of the surface-enhancing Raman scattering and to allow for measurement of a uniform signal distribution with high reproducibility.

The above technique, however, uses the slab material such as Si or Ge and the metal material such as Au, Pt, Ag, or Cu and accordingly has the complicated structure. The metal material is readily heated, so as to cause heat spots and have low biocompatibility and low reproducibility. The material such as Ge, Si or C is, on the other hand, not easily heated, so as to have high biocompatibility, high responsiveness and high reproducibility. The slab material, however, has only about 10-fold to 100-fold Raman scattering enhancing effects, which are significantly smaller than about 10⁹-fold to 10¹¹-fold effects of the metal material.

A main object of a Raman scattering enhancing-substrate of the present disclosure is to provide a carbon-based substrate having favorable Raman scattering enhancing effects. A main object of a method of manufacturing a Raman scattering enhancing-substrate of the present disclosure is to provide a method of manufacturing a carbon-based substrate having favorable Raman scattering enhancing effects.

The Raman scattering enhancing-substrate and the method of manufacturing the Raman scattering enhancing-substrate are implemented by aspects described below, in order to achieve the main objects described above.

The Raman scattering enhancing-substrate of the present disclosure having a Raman scattering enhancing effect, the Raman scattering enhancing-substrate being configured by arraying a plurality of porous carbon elements in a columnar form, in a massive form, or in a spherical form made of a porous carbon material with pores of 10 to 50 nm in diameter, on a support base.

The Raman scattering enhancing effects are thought to be attributed to the interaction between the electromagnetic effects and the chemical effects. Acceleration of the electromagnetic effects may be attributed to the electromagnetic fields locally generated at the edges of the pores in lateral surfaces of the porous carbon columns, whereas the chemical effects may be attributed to acceleration of the charge transfer deposition between the substrate and molecules. The group IV elements such as carbon (C), silicon (Si) and germanium (Ge) have high charge transfer transition efficiencies. By taking into account the foregoing, with a view to providing the favorable electromagnetic effects and the favorable chemical effects, the Raman scattering enhancing-substrate of this aspect is configured by arraying a plurality of the porous carbon elements in the columnar form or in the massive form made of the porous carbon material with the pores of 10 to 50 nm in diameter. As a result, the Raman scattering enhancing-substrate of this aspect has the favorable Raman scattering enhancing effects.

The porous carbon element in the columnar form may be formed in a cylindrical shape having a diameter of 50 to 200 nm and a length of 5 to 20 μm or in a rectangular column shape having each side of 50 to 200 nm and a length of 5 to 20 μm. The porous carbon element in the massive form has an indefinite shape but preferably has each side of not greater than 5 μm in the case of a cube form. Furthermore, the porous carbon element may have doped sulfur.

A method of manufacturing a Raman scattering enhancing-substrate having a Raman scattering enhancing effect, the method including: an array forming process of filling a template, which is made of anodic aluminum oxide to have an array of a plurality of holes in a columnar form or in a cube form, with pyrrole as a monomer, and polymerizing the pyrrole-filling template to form a polypyrrole nanoarray; a pore making process of making the entire polypyrrole nanoarray porous to provide a porous polypyrrole nanoarray that is a porous body with pores of 10 to 50 nm in diameter; and a carbonization process of carbonizing the porous polypyrrole nanoarray to provide a porous carbon nanoarray as the Raman scattering enhancing-substrate.

The method of manufacturing the Raman scattering enhancing-substrate according to this aspect of the present disclosure first fills the template that is made of anodic aluminum oxide to have the array of the plurality of holes in the columnar form or in the cube form, with pyrrole as the monomer and polymerizes the pyrrole-filling template to form the polypyrrole nanoarray. The method subsequently makes the entire polypyrrole nanoarray porous to provide the porous polypyrrole nanoarray that is the porous body with pores of 10 to 50 nm in diameter. The method then carbonizes the porous polypyrrole nanoarray to provide the Raman scattering enhancing-substrate that is the porous carbon nanoarray. This method accordingly manufactures the Raman scattering enhancing-substrate having an array of the plurality of porous carbon elements in the columnar form or in the massive form made of the porous carbon material with the holes of 10 to 50 nm in diameter.

In the method of manufacturing the Raman scattering enhancing-substrate of the above aspect, the array forming process may use the template that has an array of a plurality of holes in a cylindrical shape having a diameter of 50 to 200 nm and a length of 5 to 20 μm or in a rectangular column shape having each side of 50 to 200 nm and a length of 5 to 20 μm.

In the method of manufacturing the Raman scattering enhancing-substrate of the above aspect, the array forming process may fill the template with a solution of pyrrole as the monomer in acetonitrile and/or water and polymerize the pyrrole solution-filling template to provide the polypyrrole nanoarray.

In the method of manufacturing the Raman scattering enhancing-substrate of the above aspect, the pore making process may soak the polypyrrole nanoarray in dimethyl sulfoxide containing sulfur clusters at 80° C. to 120° C. to provide the porous polypyrrole nanoarray.

In the method of manufacturing the Raman scattering enhancing-substrate of the above aspect, the carbonization process may carbonize the porous polypyrrole nanoarray in an inert gas atmosphere at 600 to 1000° C.

### BRIEF DESCRIPTION OF DRAWINGS

FIG. 1 is a schematic configuration diagram schematically illustrating the configuration of a porous carbon nanoarray substrate 20 according to an embodiment;

FIG. 2 is an explanatory diagram showing an electron micrograph of imaging part of the porous carbon nanoarray substrate 20 according to the embodiment, along with size indication;

FIG. 3 is a schematic configuration diagram schematically illustrating the configuration of a porous carbon element 40;

FIG. 4 is a process chart showing one example of a manufacturing process of the porous carbon nanoarray substrate 20 according to the embodiment;

FIG. 5 is an explanatory diagram illustrating one example of manufacture of the porous carbon nanoarray substrate 20 according to the embodiment;

FIG. 6 is an explanatory diagram illustrating comparison of a relationship of the scattering intensity to the Raman shift between the porous carbon nanoarray substrate 20 of the embodiment and a porous polypyrrole nanoarray;

FIG. 7 is an explanatory diagram illustrating comparison of a relationship of the electric current to the applied voltage between the porous carbon nanoarray substrate 20 of the embodiment and the porous polypyrrole nanoarray;

FIG. 8 is an explanatory diagram illustrating comparison between the components of the porous carbon nanoarray substrate of the embodiment and the components of the porous polypyrrole nanoarray;

FIG. 9 is a graph showing Raman spectra of 10 μM of rhodamine 6G (R6G);

FIG. 10 is a graph showing Raman spectra of rhodamine 6G (R6G) at various concentrations in the porous carbon nanoarray substrate 20 according to the embodiment;

FIG. 11 is a graph showing relationships of the scattering intensity in Raman shift peaks to the concentration of rhodamine 6G (R6G);

FIG. 12 is a graph showing relationships of the scattering intensity in Raman shift peaks at an identical concentration of rhodamine 6G (R6G) to different porous carbon nanoarray substrates 20 according to the embodiment;

FIG. 13 is a graph showing Raman shifts and scattering intensities of β-lactoglobulin in the porous carbon nanoarray substrate 20 according to the embodiment, a silicon substrate and a metal substrate;

FIG. 14 is a graph showing Raman spectra of β-lactoglobulin at different positions on Raman scattering enhancing-substrates;

FIG. 15 is a graph showing coefficients of variation in the scattering intensity of Raman spectra of β-lactoglobulin at different positions on Raman scattering enhancing-substrates; and

FIG. 16 is a graph showing Raman spectra of amyloid-β in a silicon substrate and the porous carbon nanoarray substrate 20 of the embodiment.

### DESCRIPTION OF EMBODIMENTS

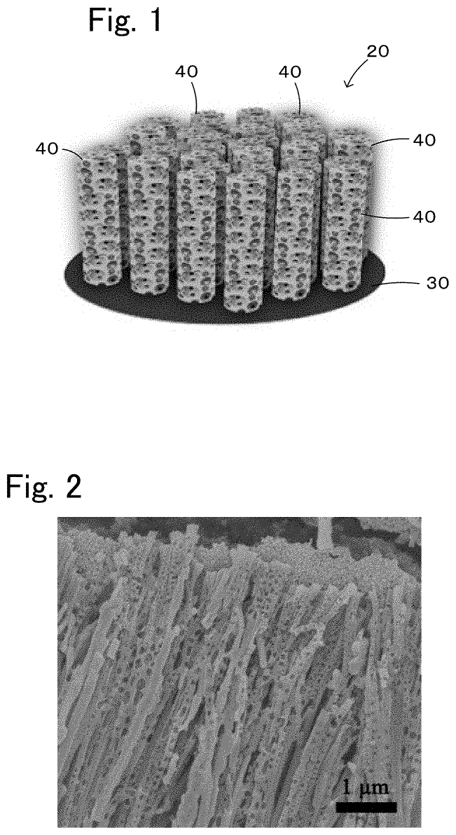

The following describes an embodiment of the present disclosure. FIG. 1 is a schematic configuration diagram schematically illustrating the configuration of a porous carbon nanoarray substrate 20 according to an embodiment. FIG. 2 is an explanatory diagram showing an electron micrograph of imaging part of the porous carbon nanoarray substrate 20 according to the embodiment, along with size indication. The porous carbon nanoarray substrate 20 of the embodiment is configured by arraying a plurality of porous carbon elements 40 in an approximately cylindrical shape, on a support base 30.

For example, silicon dioxide (SiO₂), titanium dioxide (TiO₂), silicon, a metallic glass, a polymer, a metal or the like may be used for the support base 30.

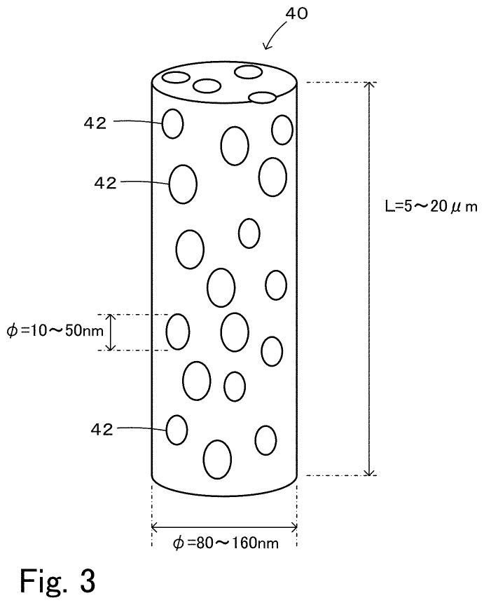

FIG. 3 is a schematic configuration diagram schematically illustrating the configuration of a porous carbon element 40. The porous carbon element 40 is made of porous carbon with a large number of pores 42 of 10 to 50 nm in diameter formed therein and is formed in an approximately cylindrical shape having a diameter of 50 to 200 nm and a length of 5 to 20 μm. These porous carbon elements 40 are arranged to stand relatively densely on the support base 30 as shown in FIG. 2.

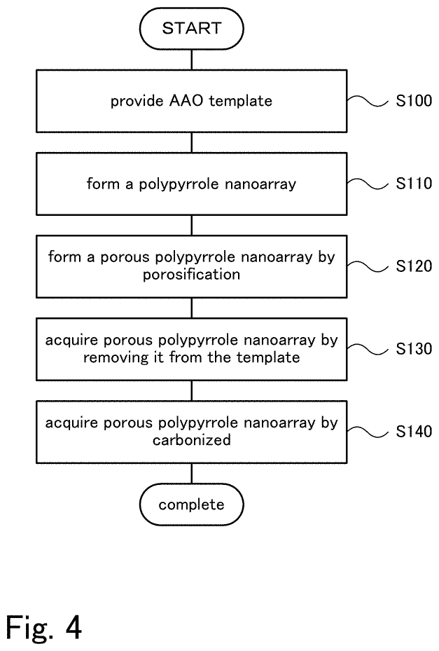

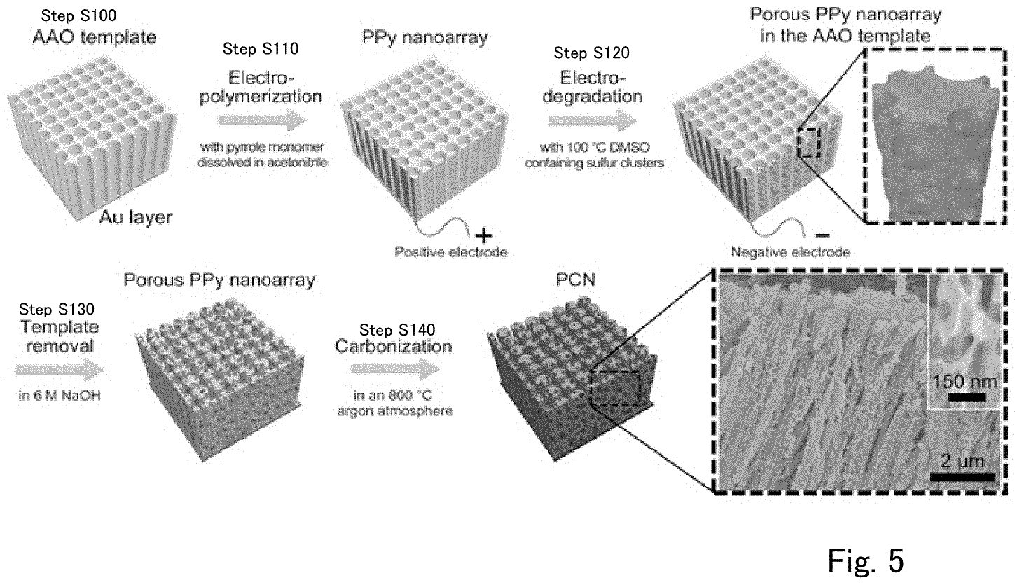

FIG. 4 is a process chart showing one example of a manufacturing process of the porous carbon nanoarray substrate 20 according to the embodiment. Numerical values in FIG. 5 are values used in the process of manufacturing the porous carbon nanoarray substrate 20 of the embodiment for evaluation of the performances of the porous carbon nanoarray substrate. A procedure of manufacturing the porous carbon nanoarray substrate 20 of the embodiment first provides a template that is made of anodic aluminum oxide (AAO) (AAO template) on an electrode layer made of gold (Au) (process S100). As shown in FIG. 5, the template is configured to have an array of a plurality of holes in a cylindrical shape having a diameter of 50 to 200 nm and a length of 5 to 20 μm. The procedure subsequently fills the plurality of holes formed in the template with a solution of pyrrole as a monomer dissolved in acetonitrile and/or water and applies a positive voltage to the electrode layer to polymerize the pyrrole and form a polypyrrole nanoarray (process S110). The procedure subsequently soaks the template with the polypyrrole nanoarray formed therein into dimethyl sulfoxide containing sulfur clusters at 80 to 120° C. and applies a negative voltage to the electrode layer to form a porous polypyrrole nanoarray that is a porous body having a large number of pores of 10 to 50 nm in diameter by electro-degradation of the polypyrrole nanoarray (process S120). The porous polypyrrole nanoarray is a porous body formed in the template to have a large number of pores of 10 to 50 nm in diameter as shown in FIG. 5. The procedure subsequently soaks the template together with the porous polypyrrole nanoarray into an aqueous solution of several M (for example, 5 M or 6 M) of sodium hydroxide (NaOH) to remove the template from the porous polypyrrole nanoarray (process S130). The procedure then carbonizes the porous polypyrrole nanoarray in an inert gas atmosphere at 600 to 1000° C. to complete the porous carbon nanoarray substrate 20 of the embodiment that is the porous carbon nanoarray (process S140).

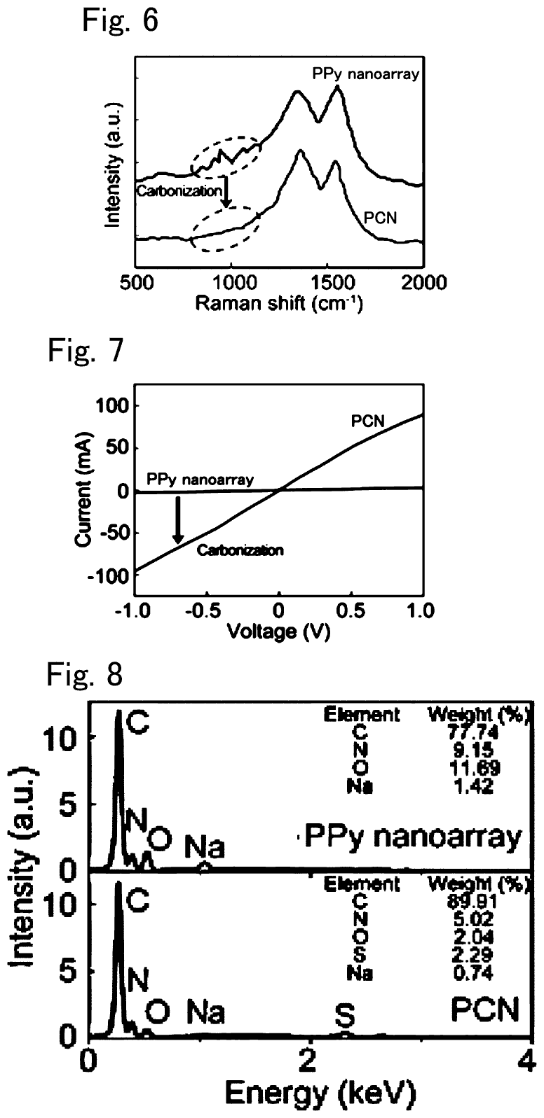

The following describes the performances of the porous carbon nanoarray substrate 20 of the embodiment. FIGS. 6 to 8 are explanatory diagrams showing comparison of the performances between the porous carbon nanoarray substrate 20 of the embodiment and a porous polypyrrole nanoarray. FIG. 6 is an explanatory diagram illustrating comparison of a relationship of the scattering intensity to the Raman shift. FIG. 7 is an explanatory diagram illustrating comparison of a relationship of the electric current to the applied voltage. FIG. 8 is an explanatory diagram illustrating comparison of the components. As shown in FIG. 6, carbonization causes the porous carbon nanoarray substrate 20 of the embodiment to have the smaller unnecessary peaks, compared with the porous polypyrrole nanoarray. Furthermore, as shown in FIG. 7, the porous carbon nanoarray substrate 20 of the embodiment has a linear current-voltage characteristic. As shown in FIG. 8, the porous carbon nanoarray substrate 20 of the embodiment has 89.91% by weight of carbon (C). 5.02% by weight of nitrogen (N), 2.04% by weight of oxygen (O), 2.29% by weight of sulfur (S), and 0.74% by weight of sodium (Na) and accordingly has the lower contents of the elements other than carbon (C) and the higher content of carbon (C), compared with the porous polypyrrole nanoarray having 77.74% by weight of carbon (C), 9.15% by weight of nitrogen (N), 11.69% by weight of oxygen (O), and 1.42% by weight of sodium (Na). Furthermore, using dimethyl sulfoxide containing sulfur clusters is used in the process of making the polypyrrole nanoarray porous causes the porous carbon nanoarray substrate 20 of the embodiment to have a small amount of doped sulfur (S) (2.29% by weight in the example of FIG. 8).

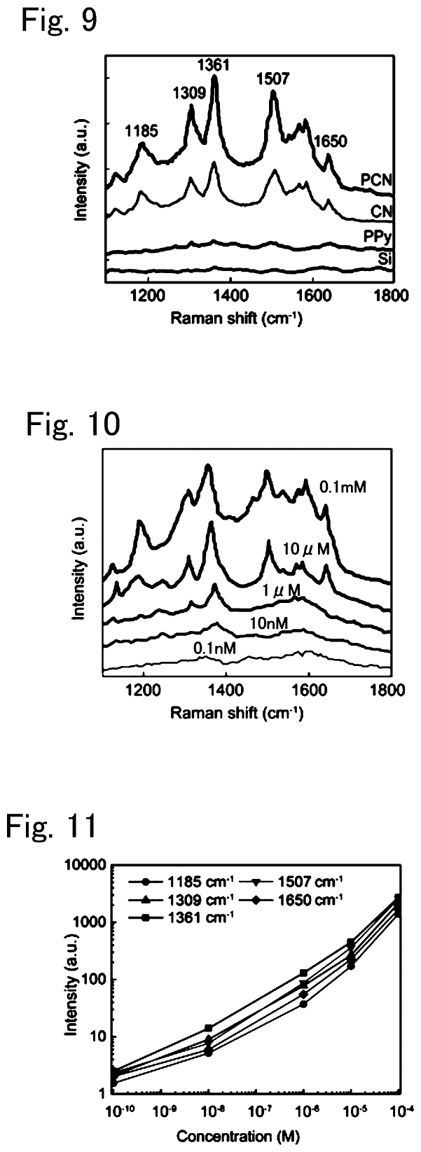

The following describes the performances of the porous carbon nanoarray substrate 20 of the embodiment. FIG. 9 is a graph showing Raman spectra of 10 μM of rhodamine 6G (R6G). The Raman shift is plotted as abscissa, and the scattering intensity as ordinate. The graph shows, from the top, Raman spectra in the case of using the porous carbon nanoarray substrate 20 of the embodiment (porous carbon nanoarray, indicated as “PCN” in the graph), in the case of using a non-porous carbon nanoarray substrate (indicated as “CN” in the graph), in the case of using a porous polypyrrole nanoarray substrate (indicated as “PPy” in the graph), and in the case of using a silicon substrate (indicated as “Si” in the graph). In the respective cases, the excitation intensity was 1 mW, and the integration time was 30 seconds. This graph shows that the porous carbon nanoarray substrate 20 of the embodiment has the more significant Raman scattering enhancing effects over the entire range of Raman shift, compared with the other substrates.

FIG. 10 is a graph showing Raman spectra of rhodamine 6G (R6G) at various concentrations in the porous carbon nanoarray substrate 20 according to the embodiment. The Raman shift is plotted as abscissa, and the scattering intensity as ordinate. The graph shows, from the top, Raman spectra of rhodamine 6G (R6G) at the concentrations of 0.1 mM, 10 μM, 1 μM, 10 nM, and 0.1 nM. At the respective concentrations, the excitation intensity was 1 mW, and the integration time was 30 seconds. This graph shows that the concentration of rhodamine 6G (R6G) of 10 μM gives a favorable Raman spectrum in the porous carbon nanoarray substrate 20 of the embodiment.

FIG. 11 is a graph showing relationships of the scattering intensity in Raman shift peaks to the concentration of rhodamine 6G (R6G). The graph shows, from the bottom, Raman shift peaks of 1185 cm⁻¹ (circle), 1650 cm⁻¹ (rhombus), 1309 cm⁻¹ (upward triangle), 1507 cm⁻¹ (downward triangle), and 1361 cm⁻¹ (square) at a concentration of 10⁻⁶ M.

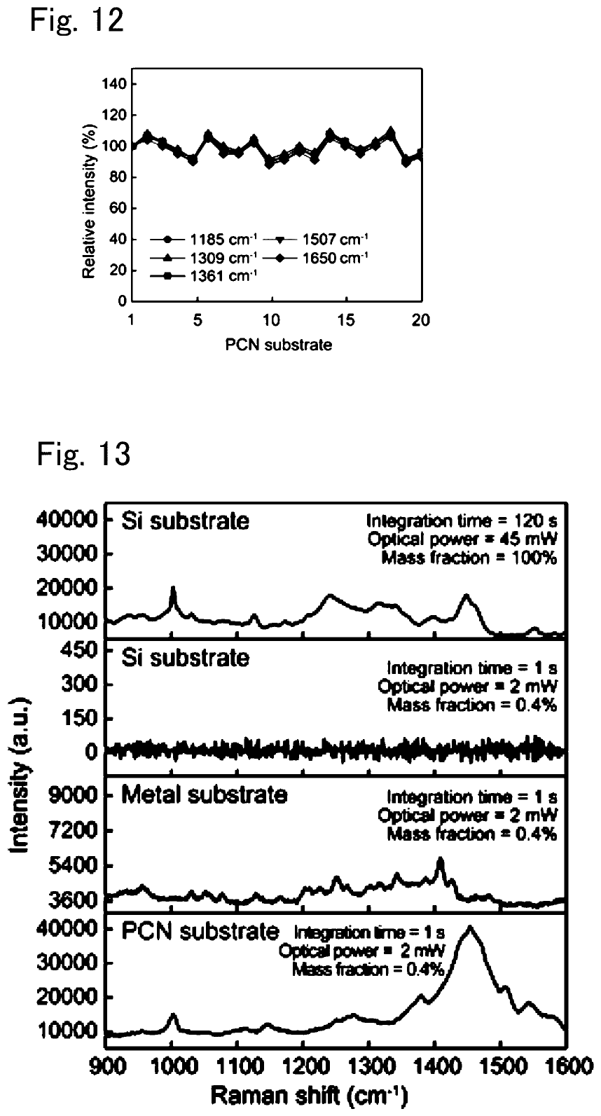

FIG. 12 is a graph showing relationships of the scattering intensity in Raman shift peaks at an identical concentration of rhodamine 6G (R6G) to different porous carbon nanoarray substrates 20 according to the embodiment. Raman shift peaks in the graph overlap with one another to be not clearly distinguishable from one another but are 1185 cm⁻¹ (circle), 1309 cm⁻¹ (upward triangle), 1361 cm⁻¹ (square), 1507 cm⁻¹ (downward triangle), and 1650 cm⁻¹ (rhombus). The scattering intensities in the respective peaks are in a range of plus 10% and minus 10% with respect to twenty porous carbon nanoarray substrates 20. This indicates the high reproducibility of the porous carbon nanoarray substrates 20 of the embodiment.

FIG. 13 is a graph showing Raman shifts and scattering intensities of β-lactoglobulin in the porous carbon nanoarray substrate 20 according to the embodiment, a silicon substrate and a metal substrate. In the graph, the top most curve shows the result in the case of using a silicon substrate as the Raman scattering enhancing-substrate under the conditions of the integration time of 120 seconds, the optical power of 45 mW, and the mass fraction of 100%. The second topmost curve shows the result in the case of using the silicon substrate under the conditions of the integration time of 1 second, the optical power of 2 mW, and the mass fraction of 0.4%. The third top most curve (the second bottom most curve) shows the result in the case of using a metal substrate as the Raman scattering enhancing-substrate under the conditions of the integration time of 1 second, the optical power of 2 mW, and the mass fraction of 0.4%. The bottom most curve shows the result in the case of using the porous carbon nanoarray substrate 20 of the embodiment under the conditions of the integration time of 1 second, the optical power of 2 mW, and the mass fraction of 0.4%. As illustrated, the porous carbon nanoarray substrate 20 of the embodiment shows the more favorable scattering intensity over the entire shift range, compared with the other Raman scattering enhancing-substrates. Especially, in a Raman shift peak of 1450 cm⁻¹, the porous carbon nanoarray substrate 20 of the embodiment shows the scattering intensity of about 10⁸-times the scattering intensity of the top most curve with respect to the silicon substrate. The results of FIG. 13 also show that the porous carbon nanoarray substrate 20 of the embodiment has the high biocompatibility.

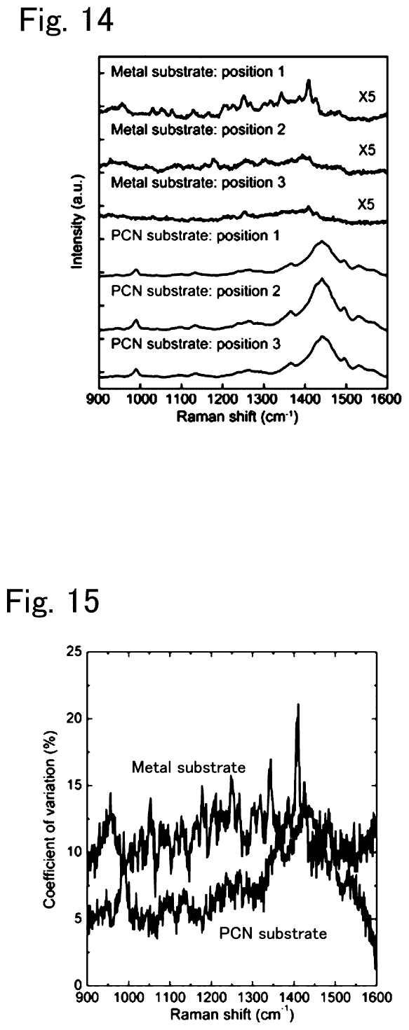

FIG. 14 is a graph showing Raman spectra of β-lactoglobulin at different positions on Raman scattering enhancing-substrates. In the graph, first three curves, from the topmost curve to the third topmost curve, are Raman spectra at positions 1 to 3 in the case of using a metal substrate as the Raman scattering enhancing-substrate, and next three curves, from the fourth top most curve to the bottom most curve, are Raman spectra at the positions 1 to 3 in the case of using the porous carbon nanoarray substrate 20 of the embodiment. FIG. 15 is a graph showing coefficients of variation in the scattering intensity of Raman spectra of β-lactoglobulin at different positions on Raman scattering enhancing-substrates. In a Raman shift range of 900 to 1400 cm⁻¹, using the metal substrate has the larger coefficient of variation, and using the porous carbon nanoarray substrate 20 of the embodiment has the smaller coefficient of variation. As shown in FIG. 14 and FIG. 15, with respect to the scattering intensities of Raman shift at the different positions of the Raman scattering enhancing-substrates, using the porous carbon nanoarray substrate 20 of the embodiment has the smaller coefficient of variation than using the metal substrate over almost the entire range of Raman shift. This shows that the porous carbon nanoarray substrate 20 of the embodiment has the favorable Raman spectra when being measured at any positions.

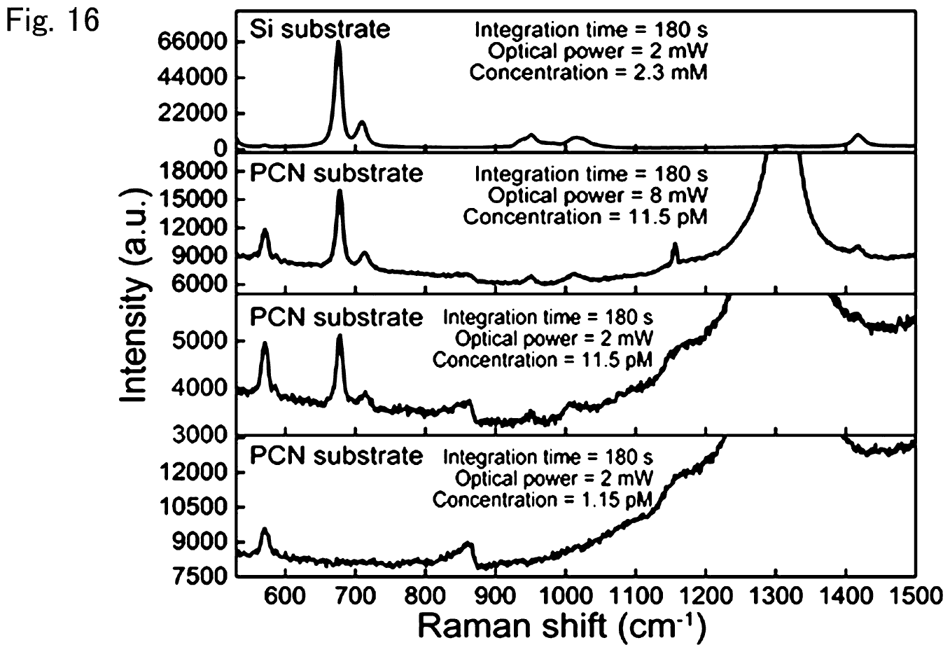

FIG. 16 is a graph showing Raman spectra of amyloid-β in a silicon substrate and the porous carbon nanoarray substrate 20 of the embodiment. In the graph, the top most curve shows the result in the case of using a silicon substrate as the Raman scattering enhancing-substrate under the conditions of the integration time of 180 seconds, the optical power of 2 mW, and the concentration of 2.3 mM. The second top most curve shows the result in the case of using the porous carbon nanoarray substrate 20 of the embodiment under the conditions of the integration time of 180 seconds, the optical power of 8 mW, and the concentration of 11.5 pM. The third top most curve shows the result in the case of using the porous carbon nanoarray substrate 20 of the embodiment under the conditions of the integration time of 180 seconds, the optical power of 2 mW, and the concentration of 11.5 pM. The bottommost curve shows the result in the case of using the porous carbon nanoarray substrate 20 of the embodiment under the conditions of the integration time of 180 seconds, the optical power of 2 mW, and the concentration of 1.15 pM In the respective cases, dimethyl sulfoxide (DMSO) was used as the solvent of amyloid-β. As illustrated, the porous carbon nanoarray substrate 20 of the embodiment has the favorable Raman spectrum at the concentration of amyloid-β of 11.5 pM. It is thought that abnormal deposition of amyloid-β in the brane causes Alzheimer's disease.

As described above, the porous carbon nanoarray substrate 20 of the embodiment is configured to have the array of a plurality of the porous carbon elements 40 in the columnar form made of the porous carbon material with the pores of 10 to 50 nm in diameter and accordingly shows the favorable Raman scattering enhancing effects. Furthermore, the porous carbon nanoarray substrate 20 of the embodiment has the high biocompatibility, the high responsiveness and the high reproducibility.

The method of manufacturing the porous carbon nanoarray substrate according to the embodiment is configured to manufacture the porous carbon nanoarray substrate 20 that is the Raman scattering enhancing-substrate having an array of a plurality of the porous carbon elements 40 in a columnar form or in a massive form made of the porous carbon material with the pores of 10 to 50 nm in diameter.

The porous carbon nanoarray substrate 20 of the embodiment is configured to have the array of a plurality of the porous carbon elements 40 in the columnar form made of the porous carbon material with the pores of 10 to 50 nm in diameter. The porous carbon nanoarray substrate may, however, be configured to have an array of a plurality of porous carbon elements in a cube form, in a spherical form, or in an amorphous massive form made of the porous carbon material with the pores of 10 to 50 nm in diameter.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The technique of the disclosure is applicable to the manufacturing industries of a Raman scattering enhancing-substrate and so on.

1. A Raman scattering enhancing-substrate having a Raman scattering enhancing effect, the Raman scattering enhancing-substrate being configured by arraying a plurality of porous carbon elements in a columnar form, in a massive form, or in a spherical form made of a porous carbon material with pores of 10 to 50 nm in diameter, on a support base.

2. The Raman scattering enhancing-substrate according to claim 1,
wherein the porous carbon element is formed in a cylindrical shape having a diameter of 50 to 200 nm and a length of 5 to 20 μm or in a rectangular column shape having each side of 50 to 200 nm and a length of 5 to 20 μm.

3. The Raman scattering enhancing-substrate according to claim 1,
wherein the porous carbon element has doped sulfur.

4. A method of manufacturing a Raman scattering enhancing-substrate having a Raman scattering enhancing effect, the method comprising:
an array forming process of filling a template, which is made of anodic aluminum oxide to have an array of a plurality of holes in a columnar form or in a cube form, with pyrrole as a monomer, and polymerizing the pyrrole-filling template to form a polypyrrole nanoarray;
a pore making process of making the entire polypyrrole nanoarray porous to provide a porous polypyrrole nanoarray that is a porous body with pores of 10 to 50 nm in diameter; and
a carbonization process of carbonizing the porous polypyrrole nanoarray to provide a porous carbon nanoarray as the Raman scattering enhancing-substrate.

5. The method of manufacturing the Raman scattering enhancing-substrate according to claim 4,
wherein the array forming process uses the template that has an array of a plurality of holes in a cylindrical shape having a diameter of 50 to 200 nm and a length of 5 to 20 μm or in a rectangular column shape having each side of 50 to 200 nm and a length of 5 to 20 μm.

6. The method of manufacturing the Raman scattering enhancing-substrate according to claim 4,
wherein the array forming process fills the template with a solution of pyrrole as the monomer in acetonitrile and/or water and polymerizes the pyrrole solution-filling template to provide the polypyrrole nanoarray.

7. The method of manufacturing the Raman scattering enhancing-substrate according to claim 4,
wherein the pore making process soaks the polypyrrole nanoarray in dimethyl sulfoxide containing sulfur clusters at 80° C. to 120° C. to provide the porous polypyrrole nanoarray.

8. The method of manufacturing the Raman scattering enhancing-substrate according to claim 4,
wherein the carbonization process carbonizes the porous polypyrrole nanoarray in an inert gas atmosphere at 600 to 1000° C.
